(19) United States
(12) Patent Application Publication
(10) Pub. No.: US 2026/0175829 A1
(43) Pub. Date: Jun. 25, 2026

(54) A Method for Operating an Assistance System of a Vehicle for Carrying Out a Turning Maneuver, Computing Device, Computer-Readable Storage Medium, Assistance System, and a Vehicle

(71) Applicant: Bayerische Motoren Werke Aktiengesellschaft, Muenchen (DE)

(72) Inventor: Dominik HARTL, Muenchen (DE)

(21) Appl. No.: 19/124,987

(22) PCT Filed: Oct. 19, 2023
(86) PCT No.: PCT/EP2023/079082

§ 371 Date: Apr. 28, 2025

(30) Foreign Application Priority Data
Nov. 18, 2022 (DE) 10 2022 130 622.4

(51) Int. Cl. B60W 10/18; B60W 30/06; B60W 30/095; B60W 50/08; B60W 50/14; B62D 15/02

(52) U.S. Cl. CPC B60W 10/18; B60W 30/06; B60W 30/0956; B60W 50/082; B60W 50/14; B62D 15/0285

(57) ABSTRACT

A method for operating an assistance system of a vehicle to perform a turning maneuver includes receiving an operating input from a user of the vehicle, the operating input providing instructions for the turning maneuver. The operator input describes a predefined target position for the turning maneuver. The turning maneuver is executed depending on the operator input, the execution of the turning maneuver being at least partially automated.

### BACKGROUND AND SUMMARY

The present disclosure relates to a method for operating an assistance system of a vehicle for carrying out a turning maneuver. In addition, this disclosure relates to a computing device for a vehicle. Further, the present disclosure relates to a computer-readable storage medium as well as an assistance system for a vehicle. Finally, the present disclosure relates to a vehicle.

Modern vehicles nowadays have numerous assistance systems which support the user of the vehicle in maneuvering, parking or the like. For example, modern vehicles have rear view cameras or generate a so-called top view image with a plurality of cameras. Moreover, modern vehicles can also assume longitudinal and/or lateral control during a parking operation.

However, carrying out a turning maneuver poses special challenges for the user of the vehicle. For instance, often times several gear changes must be carried out, an often poorly visible surrounding area must be monitored and critical scenarios with further traffic participants must be anticipated. Simultaneously, the applicable traffic laws must be observed. Hence, a turning maneuver poses special challenges to the user of the vehicle and consequently, can lead to stress and overload.

The publication DE 10 2011 110 214 A1 describes a method and a corresponding device for turning a motor vehicle, wherein the motor vehicle has an environment sensor system for determining the environment of the motor vehicle. A contour of the navigable regions of the environment of the motor vehicle is determined by means of the environment sensor system and a turn signal is generated when a sufficiently large turning area for a turning maneuver is recorded using the determined contour.

The published application DE 10 2015 008 446 A1 relates to a method for operating a driver assistance system of a motor vehicle having the steps: determining a necessary time period for carrying out a turning maneuver of the motor vehicle on a section of the road driven with the motor vehicle; recording of traffic conditions in an environment of the motor vehicle comprising the navigable section of the road; using the determined traffic conditions to check whether the carrying out of the turning maneuver on the section of the road is non-critical; if the carrying out of the turning maneuver is categorized as non-critical: automatic carrying out of the turning maneuver.

The document DE 10 2019 000 447 A1 relates to a method for turning a vehicle, in which an environment of the vehicle is monitored, wherein a turning operation is carried out depending on the environmental monitoring program. In the case of a method with which dangerous situations are suppressed, after inputting a signal the turning operation of the vehicle is automatically carried out.

The embodiments described herein address the problem of showing a solution for supporting the user of a vehicle above and beyond the prior art in the carrying out of a turning maneuver.

This problem is solved according to the method(s), by computing device(s), computer-readable storage medium(s), assistance system(s), as well as by vehicle(s) having the features described herein.

Within the scope of the document, the term “automated driving” is understood to be driving with automated longitudinal and/or lateral control. For example, automated driving can be a protracted driving on the highway or a time-limited driving within the scope of parking. The term “automated driving” includes automated driving with any degree of automation. Exemplary automation degrees are assisted, partially automated, conditionally automated, highly automated and fully automated driving (with respective increasing degree of automation). The foregoing mentioned five automation degrees correspond to SAE-Levels 1 to 5 of the SAE J3016 norm (SAE-Society of Automotive Engineering) as of 30th April 2021. In the case of assisted driving (SAE-Level 1), the system carries out the longitudinal or lateral control in specified driving situations. With partially automated driving (SAE-Level 2) the system assumes the longitudinal and/or lateral control in specified driving situations, wherein the driver must constantly monitor the system, as with assisted driving. In the case of conditionally automated driving (SAE-Level 3) the system carries out the longitudinal and/or lateral control in specified driving situations, without the driver having to constantly monitor the system, but the driver must be able to assume responsibility for driving the vehicle in a certain period of time upon request from the system. In highly automated driving (SAE-Level 4) the system assumes responsibility for driving the vehicle in specified driving situations, even if the driver does not respond to a request for intervention, so that the driver is omitted as a fallback solution. In the case of fully automated driving (SAE-Level 5) the system can undertake all aspects of the dynamic driving task under all road and environmental conditions, which are also controlled by a human driver.

Furthermore, within the scope of the document, the term “at least partially automated driving or maneuvering” is understood as partially automated, conditionally automated, highly automated, fully automated driving. In other words, the term of “at least partially automated driving” is understood to be an automation degree from and including SAE-Level 2.

A method for operating an assistance system of a vehicle for carrying out a turning maneuver comprises a receiving of an operator input of a user of the vehicle, wherein by means of the operator input instructions for the turning maneuver may be provided. Moreover, the method comprises an at least partially automated carrying out of the turning maneuver depending on the user operator input. To this end, operator input describes a predefined target position for the turning maneuver.

The method can for example be carried out by means of a computing device. The computing device can for example be configured as at least one electronic controller of the vehicle, which comprises one or more programmable processors. In addition, the computing device can have a computer-readable storage medium, on which a computer program is stored. To carry out corresponding procedural steps, such as for example the receiving of the operator input, the computer program can be executed on the computing device.

Thus, the method supports the user of the vehicle in an operation of the assistance system to carry out the turning maneuver. The user of the vehicle may for example be the driver of the vehicle or also a passenger of the vehicle. Furthermore, it is also conceivable that the user of the vehicle is a person outside of the vehicle with a remote control for tele-operative control of the vehicle.

The user of the vehicle may for example actuate the operator input by means of a touchscreen display, a voice control, a gesture control, an eye gaze control or a classical control element. Well-suited as a classical control element for example is a so-called rotary push actuator, an outside rear-view mirror adjustment mechanism, a joystick or the like. Furthermore, it is conceivable that the operator input takes place with classical pushbuttons. The latter is in particular conceivable when it is a question of confirmation of the target position or as the operator input or as part of the operator input.

The turning maneuver is usually used to change the forward direction of the vehicle by 180°. However, it may also be advantageous if the orientation of the vehicle can be customized for any situation. In other words, it may be advantageous if the forward direction differs from the initial situation after carrying out the turning maneuver by, for example 150 to 210°. As a result, if necessary, a continuation of travel subsequent to the turning maneuver can be made easier for the user of the vehicle. In addition, the user can in this way initiate the turning maneuver himself or carry out a first turn of the turning maneuver and subsequently be supported by the assistance system.

The operator input comprises a predefined target position for the turning maneuver. The predefined target position can be the position of the turning maneuver which marks the end of the turning maneuver. In this connection, it is also conceivable that the predefined target position is proposed by the assistance system. The operator input can in such a case describe a simple confirmation of the predefined target position. Alternately or in addition, the predefined target position can also be predefined by the user. The above-described operating devices or controls control elements are well-suited for this purpose.

Finally, the turning maneuver can be planned by the assistance system such that the turning maneuver ends in the predefined target position. To this end, the assistance system can plan the necessary trajectories as well as the corresponding gear changes. Thereupon, the turning maneuver, which is supposed to end in the predefined target position and therefore occurs depending on the operator input, can be carried out at least partially automated. For this purpose, it is conceived that the assistance system or the computing device communicates with a central controller and the central controller controls the actuators of the vehicle.

By means of the method, an intuitive operation of the assistance system for carrying out the turning maneuver arises for the user of the vehicle. As a result, additional stress due to a necessary turning maneuver can be lowered. Furthermore, the continuation of travel subsequent to the turning maneuver can be designed to be correspondingly easy.

It can be advantageous in this context if a yaw angle for the predefined target position of the turning maneuver is specified. For example, let us suppose the driver of the vehicle does not necessarily wish to turn by 180°. Instead, in some situations it can be helpful if the orientation of the vehicle after carrying out the turning maneuver vis-à-vis the initial position of the vehicle lies in an angular region of, for example 150 to 210°. In other words, it can be helpful if the target position is predefined in lateral and longitudinal direction and additionally a yaw angle of the vehicle for the orientation of the vehicle or for fine adjustment of the direction of travel is predefined.

A further advantageous embodiment of the method provides that in addition, an environmental model is output, which describes an environment of the vehicle and the predefined target position for the turning maneuver is described in dependence thereon. Typically, the vehicle records its environment by means of environmental sensors. Usually radar, lidar, ultrasound sensors and/or cameras are used as environmental sensors. The sensor data recorded by means of the environmental sensors can subsequently be consolidated by the vehicle to an environmental model. The environmental model can thus be used for planning trajectories and hence for carrying out various assistance functions of the vehicle.

The environmental model can describe the environment of the vehicle. The environmental model can, for example be displayed to the driver or the user via a display. If the user starts the assistance system for carrying out the turning maneuver, a predefined target position can be proposed to the user, which is displayed to said user on the display within the environmental model. The driver or user of the vehicle can change the predefined target position within the environmental model by means of a touch control. The predefined target position can thus be described depending on the environmental model. In other words, the predefined target position can be described relative to its own vehicle position, or relative to objects in the environment of the vehicle. In this way a simple operation of the assistance system for carrying out the turning maneuver is made possible for the user of the vehicle. The user of the vehicle is able to get his bearings by means of the environmental model and thus predefine a desired position, in which the turning maneuver should end, to the assistance system for carrying out the turning maneuver. This facilitates an intuitive operation and hence lowers the stress for the user of the vehicle in what is already a challenging situation.

Moreover, it can be advantageous if, in addition a target position proposal is output, wherein the target position proposal describes an initial proposal for the predefined target position of the turning maneuver. If the user of the vehicle for example starts the assistance system for carrying out the turning maneuver, a proposal for a possible predefined target position of the turning maneuver can be output to the user of the vehicle.

Such a proposal for a predefined target position is for example known from parking assistants. In this connection, after driving past a parking space the parking space is proposed as a possible target destination to the driver or the user of the vehicle. Thus, if the user of the vehicle or the vehicle is on a two-lane road, for example a target position proposal which describes a predefined target position on the adjacent traffic lane can be output. In the simplest case, the carrying out of the turning maneuver can be started immediately by actuation. The user of the vehicle is thus additionally supported in a challenging situation, saves time and does not have to concern himself unnecessarily with the operation or the operator input.

In this connection, it can be further advantageous if the predefined target position is described depending on a change of the target position proposal. A change or a modification of the initial proposal for the predefined target position can make it easier for the user of the vehicle to get his bearings within the environmental model and hence make the operator input easier. In addition, the changing of the target position proposal can promote the intuitiveness of the overall system. For example, if the environmental model is output on a touchscreen, the user of the vehicle can be encouraged to interact with the touchscreen and thus to change the target position proposal.

A further advantageous embodiment of the method provides that an initial availability check is carried out prior to carrying out the turning maneuver, in which it is checked whether the predefined target position is available in consideration of applicable traffic laws. In addition, the advantageous embodiment provides that a notice (to the user of the vehicle) is output depending on the initial availability check. In carrying out a turning maneuver with a vehicle there are certain things to take into account in traffic. If applicable rules for turning are not observed, under circumstances high fines may be imposed. For example, if the predefined target position is on an adjacent traffic lane of the current traffic lane, upon which the vehicle is located, and the two traffic lanes are separated from one another by a continuous line, carrying out the turning maneuver would mean driving over the traffic lane in violation of the law. This would result in a fine, which would be even higher in the event of danger.

Traffic lanes or center lines are usually part of the environmental model and are typically recorded by means of a camera or lidar sensor. Within the scope of the initial availability check, this makes it possible to check whether any planned trajectories violate applicable traffic laws. It is particularly important in this regard to take into consideration the endangerment of other traffic participants, any traffic lanes, directions of travel and potential restricted areas stipulated by arrows/signs. If the predefined target position cannot be reached without violating applicable traffic laws, a notice can be output. This can ensure that the user is always integrated into ongoing operations and thus informed about any system boundaries.

Nevertheless, it may be advantageous if the turning maneuver can be carried out after a corresponding confirmation by the user of the vehicle. This is in particular helpful if the user of the vehicle finds themselves in an emergency situation. Such a confirmation can for example occur by tapping the gas pedal or a simple okay by means of a further operator input. This ensures that the assistance system complies with applicable traffic laws and that the vehicle user can also access the assistance system in emergency situations.

A further advantageous embodiment of the method provides that a continuous availability check is carried out during the turning maneuver, which checks whether the predefined target position is still available. If the predefined target position is unavailable, a corrected target position can be used as the predefined target position for the turning maneuver. A turning maneuver usually takes place in several stages and is carried out in an ever-changing scenario. It may happen that, due to changing positions of further traffic participants or of objects in the environment during the execution of the turning maneuver a new situation to be assessed arises. For example, a further traffic participant may suddenly block the predefined target position during the execution of the turning maneuver. Consequently, the turning maneuver may be aborted or paused.

Alternatively, the turning maneuver may however also be continued with a corrected target position. In this connection, it may be necessary to plan new trajectories and gear changes. However, in the simplest case the turning maneuver can be continued as far as possible due to the new situation that has occurred. This can increase the comfort for the user of the vehicle. Furthermore, a system discard can be prevented. In addition, a form of artificial intelligence can be conveyed to the user of the vehicle.

In this context, it may be advantageous if an object in the environment of the vehicle, due to which the predefined target position is unavailable, is recorded and characterized, and the corrected target position is determined depending on the recorded and characterized object. For example, if a further traffic participant blocks the predefined target position of the turning maneuver due to a diverting traffic jam, it may be advantageous if the further traffic participant is assessed as only a temporary obstacle. Consequently, the turning maneuver may for example be paused. As soon as the diverting traffic jam clears and the further traffic participant is no longer blocking the predefined target position, the turning maneuver can be resumed.

Thus, it may be advantageous in this connection if the recorded and characterized object is at least characterized as temporary or permanent. The turning maneuver may be paused or continued with a corrected target position due to the characterization as temporary or permanent. For example, if the recorded and characterized object in the environment of the vehicle is an (illegally) parking vehicle, a corrected target position before, behind or next to the recorded and characterized object may be used as the predefined target position. The turning maneuver can thus be executed in spite of an obstacle which proves to be an obstacle during the execution of the turning maneuver. Overall, this can increase the comfort for the vehicle user and thus the overall benefit of the assistance system. Complex situations which require the turning of the vehicle can thus be avoided for the user of the vehicle. Overall, stress can thus also be reduced in complex situations.

A computing device for a vehicle is set up to execute the method(s) described herein. The computing device can for example be designed as an electronic controller, which comprises one or more programmable processors.

A computer-readable storage medium comprises commands which, in the event of their execution by a computing device, cause it to execute the method(s) described herein.

An assistance system for a vehicle comprises the computing device(s) described herein. In addition, an assistance system comprises a display and input device for a vehicle which is set up to display an environmental model output by the computing device described herein, and to record an operating input of a user of the vehicle, wherein the operator input describes a predefined target position for a turning maneuver.

A vehicle comprises the assistance system(s) described herein. The vehicle can in particular be configured as a passenger car.

A further aspect relates to a computer program, comprising commands which, in the event of the execution of the program by a computing device cause said computing device to execute the method(s) described herein.

The preferred embodiments presented with respect to the method(s) and their advantages apply correspondingly for the computing device, for the computer-readable storage medium, for the assistance system, as well as for the vehicle. In addition, the preferred embodiments presented with respect to the method(s) and their advantages also apply for the computer program.

Further features arise from the claims, the figures and the description of the figures. The features and feature combinations mentioned above in the description as well as the features and feature combinations mentioned subsequently in the description of the figures and/or the features and feature combinations shown solely in the figures may be used not only in the respective specified combination, but also in other combinations or alone, without departing from the scope of the invention.

The invention will now be described in greater detail on the basis of preferred exemplary embodiments as well as with reference to the attached drawings.

### BRIEF DESCRIPTION OF THE DRAWINGS

FIG. 1 shows a schematic representation of a vehicle which comprises an assistance system for carrying out a turning maneuver

FIG. 2 shows a schematic representation of a display and input device, by means of which a user of the vehicle can predefine a target position for the turning maneuver,

FIG. 3a, b shows a schematic representation of the display and input device according to FIG. 2, wherein different variants for the representation of an environmental model of the vehicle are shown, and

FIG. 4 shows a schematic representation of the execution of the turning maneuver.

### DETAILED DESCRIPTION OF THE DRAWINGS

In the figures, identical elements or elements identical in function are provided with the same reference numerals.

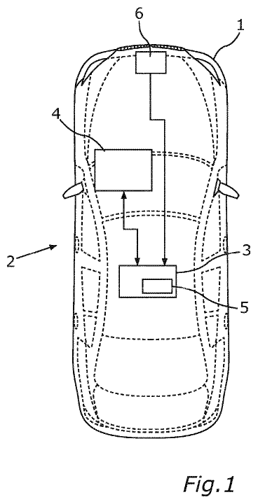

FIG. 1 shows a schematic representation of a vehicle 1, shown here as a passenger car in top view. The vehicle 1 comprises an assistance system 2 for carrying out a turning maneuver 9. The assistance system 2 comprises a computing device 3 and a display and input device 4. The computing device 3 comprises in turn a computer-readable storage medium 5, upon which a computer program is stored. Finally, the vehicle 1 comprises an environmental sensor 6.

The user 7 of the vehicle 1 can actuate an operating input by means of the display and input device 4. The operating input can describe a predefined target position 8 for the turning maneuver 9.

The computing device 3 can receive the operating input of the user 7 of the vehicle 1. Subsequently, a trajectory, comprising possible changes in the direction of travel, can be planned for the turning maneuver 9 by the assistance system 2 or by means of the computing device 3. Finally, the turning maneuver 9 can be carried out at least partially automated depending on the operating input. The turning maneuver 9 can end in the predefined target position 8.

An environmental model 10 can be provided by means of the environmental sensor 6 as well as optionally additional environmental sensors, whose data can be merged. The environmental model 10 can be represented by means of the display and input device 4.

The computing device 3 can be an electronic controller of the vehicle 1, which comprises one or more programmable processors. The computing device 3 can also be a central computing device of the vehicle 1. The computing device 3 can additionally be set up to control the actuators for carrying out the longitudinal and/or lateral control of the vehicle 1.

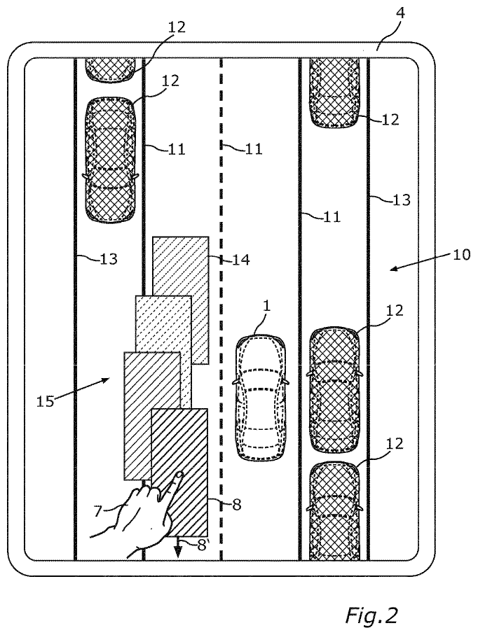

FIG. 2 shows a schematic representation of the display and input device 4 in the form of a touchscreen. An environmental model 10 of the vehicle is shown on the display of the display and input device 4. The environmental model 10 can for example describe road markings 11 as well as further traffic participants 12. In addition, the environmental model 10 can describe curbs 13.

If the user 7 of the vehicle 1 starts the assistance system 2 for carrying out a turning maneuver 9, a target position proposal 14 can be output or shown on the display of the display and input device 4. The user 7 of the vehicle 1 can accept the target position proposal 14, which describes an initial proposal for the predefined target position 8 of the turning maneuver 9, as a predefined target position 8 or describe the predefined target position 8 depending on the environmental model 10 by making a change 15 to the target position proposal 14.

The arrow 8′ of the predefined target position 8 in the exemplary embodiment of FIG. 2 displays the direction of travel subsequent to the execution of the turning maneuver 9. Typically, the direction of travel after execution of the turning maneuver 9 deviates by 180° from the original direction of travel of the vehicle 1. However, it can be advantageous if a yaw angle can be predefined, for example by turning with two fingers on the touchscreen of the display and input device 4, so that the turning maneuver 9 describes a turning of the vehicle 1 in such a way that the orientation of the vehicle 1 after execution of the turning maneuver 9 differs from the starting position by for example 150°, 160°, 170°, 180°, 190°, 200° or 210°. Corresponding intermediate steps with an increment of one or five degrees are likewise conceivable.

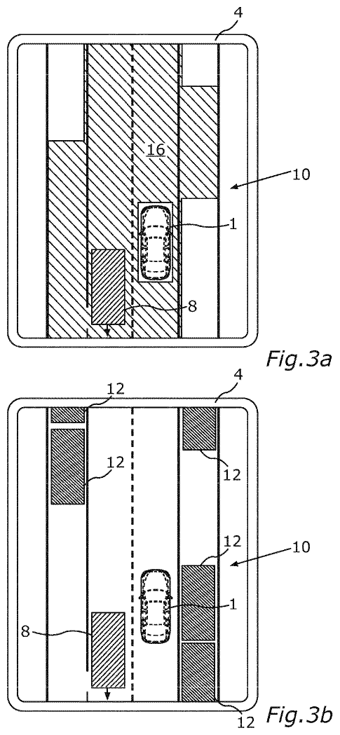

FIG. 3a and FIG. 3b show a schematic representation of the display and input device 4 analogous to FIG. 2. FIG. 3a and FIG. 3b show further possibilities of representing the environmental model 10. In FIG. 3b for example the environmental model 10 is described essentially by an open space 16, within which the user 7 of the vehicle 1 can predefine the predefined target position 8 for the turning maneuver 9. In contrast to this, FIG. 3a shows a simplified representation of the environmental model 10 from FIG. 2. The exemplary embodiments of FIGS. 3a and 3b can also be well suited, in particular if there is not much computing power and/or a simpler representation is desired.

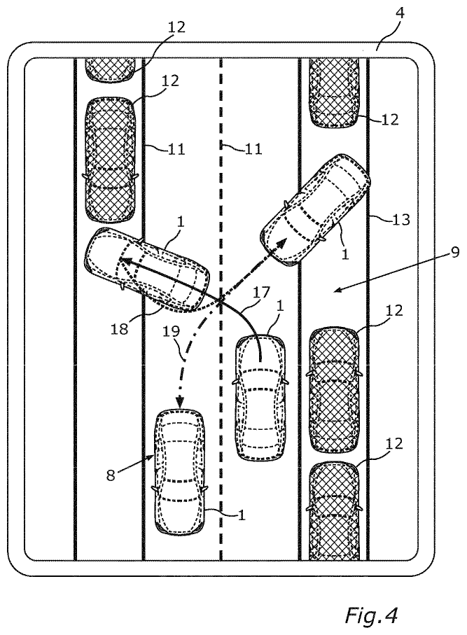

FIG. 4 shows a schematic representation of the display and input device 4 according to FIG. 2. Depending on the predefined target position 8, the trajectories 17, 18, 19 may be planned. To prepare the user 7 of the vehicle 1 for the upcoming turning maneuver 9, the turning maneuver 9 can be visualized (animated) on the display and input device 4.

1-12. (canceled)

13. A method for operating an assistance system of a vehicle to carry out a turning maneuver, the method comprising:
receiving an operating input of a user of the vehicle, wherein by means of the operating input instructions for the turning maneuver are provided, and wherein the operating input describes a predefined target position for the turning maneuver; and
carrying out of the turning maneuver depending on the operating input, wherein the turning maneuver is carried out at least partially autonomously.

14. The method of claim 13, wherein an environmental model is output, which describes an environment of the vehicle and depending thereupon the predefined target position for the turning maneuver is described.

15. The method of claim 13, wherein a target position proposal is output, and wherein the target position proposal describes an initial proposal for the predefined target position of the turning maneuver.

16. The method of claim 15, wherein the predefined target position is described depending on a change of the target position proposal.

17. The method according to claim 13, wherein an initial availability check is carried out prior to carrying out the turning maneuver, in which a check is performed whether the predefined target position is available in consideration of applicable traffic laws, and wherein a notice is output depending on the initial availability check.

18. The method of claim 13, wherein a continuous availability check is carried out during the carrying out of the turning maneuver, in which a check is performed whether the predefined target position is still available, and wherein a corrected target position is used as the predefined target position for the turning maneuver, provided the predefined target position is unavailable.

19. The method according to claim 18, wherein an object in the environment of the vehicle, due to which the predefined target position is unavailable, is recorded and characterized, and wherein the corrected target position is determined depending on the recorded and characterized object.

20. The method according to claim 19, wherein the recorded and characterized object is at least characterized as temporary or permanent.

21. A non-transitory computer readable medium storing instructions executable by a computing device to perform the method of claim 13.

22. An assistance system of a vehicle, comprising:
a computing device configured to execute the method of claim 13; and
a display and input device for the vehicle, which is configured to display an environmental model output by the computing device and to record the operating input of a user of the vehicle, wherein the operator input describes the predefined target position for the turning maneuver.
